(19) United States
(12) Patent Application Publication
(10) Pub. No.: US 2026/0194042 A1
(43) Pub. Date: Jul. 9, 2026

(54) CORNER CASTING PIN LOCK DEVICES, SYSTEMS, AND METHODS

(71) Applicant: BNSF Logistics, LLC, Dallas, TX (US)

(72) Inventors: Alberto J. Alvarez, Coppell, TX (US); James H. Jones, III, Plano, TX (US); James W.V. Tabije, Coppell, TX (US); Billy Ray Goodwin, Richland Hills, TX (US); Alejandra Soltero, Fort Worth, TX (US)

(73) Assignee: BNSF Logistics, LLC, Dallas, TX (US)

(21) Appl. No.: 19/012,533

(22) Filed: Jan. 7, 2025

(51) Int. Cl. F03D 13/40

(52) U.S. Cl. CPC F03D 13/401; F05B 2260/02; F05B 2260/30

(57) ABSTRACT

A corner casting pin locking system includes a corner casting having a side aperture, a locking tab having a tab aperture, and a corner casting insert having a pin lock aperture and configured to be at least partially inserted into the corner casting. The system further includes a corner casting pin lock configured to be inserted through the side aperture of the corner casting and at least partially through the pin lock aperture of the corner casting insert. The corner casting pin lock includes an engagement member and a handle coupled to the engagement member. The handle includes a padlock aperture on a distal end of the handle opposite the engagement member. The corner casting pin lock is configured to be rotated by the handle until the distal end of the handle contacts the locking tab and the padlock aperture is aligned with the tab aperture of the locking tab.

### TECHNICAL FIELD

This disclosure generally relates to corner castings such as those used for shipping containers, and more specifically to corner casting pin lock devices, systems, and methods.

### BACKGROUND

Corner castings are bulky metal structural objects that are used for securing large items such as shipping containers during transport. Corner castings are typically hollow, cube-shaped objects that have apertures on multiple sides that permit locking devices to be inserted into and operated within the corner casting. A typical locking device that is used to secure corner castings of objects such as shipping containers is a twist lock. Typical locking devices such as twist locks, while suitable for many applications, are not appropriate or effective for some transport applications involving corner castings.

### SUMMARY

The present disclosure achieves technical advantages as systems, devices, and methods for securing corner castings using corner casting pin locks. In some embodiments, a corner casting pin locking system includes a corner casting having a side aperture. The corner casting pin locking system further includes a locking tab having a tab aperture. The corner casting pin locking system further includes a corner casting insert configured to be at least partially inserted into the corner casting as the corner casting is lowered onto the corner casting insert. The corner casting insert includes a pin lock aperture. The corner casting pin locking system further includes a corner casting pin lock that is configured to be inserted through the side aperture of the corner casting and at least partially through the pin lock aperture of the corner casting insert. The corner casting pin lock includes an engagement member and a handle coupled to the engagement member. The handle includes a padlock aperture on a distal end of the handle opposite the engagement member. The corner casting pin lock is configured to be rotated by the handle, after being inserted through the side aperture of the corner casting and at least partially through the pin lock aperture of the corner casting insert, until the distal end of the handle contacts the locking tab and the padlock aperture is aligned with the tab aperture of the locking tab.

In some embodiments, a wind turbine blade transport system includes a turbine blade fixture configured to secure one end of a turbine blade. The turbine blade fixture includes a corner casting having a side aperture. The wind turbine blade transport system further includes a pedestal configured to removably couple to the turbine blade fixture. The pedestal includes a locking tab having a tab aperture and a corner casting insert that is configured to be at least partially inserted into the corner casting of the turbine blade fixture as the turbine blade fixture is lowered onto the pedestal. The corner casting insert includes a pin lock aperture. The wind turbine blade transport system further includes a corner casting pin lock that is configured to be inserted through the side aperture of the corner casting and at least partially through the pin lock aperture of the corner casting insert. The corner casting pin lock includes an engagement member and a handle coupled orthogonally to the engagement member. The handle includes a padlock aperture on a distal end of the handle opposite the engagement member. The corner casting pin lock is configured to be rotated by the handle, after being inserted through the side aperture of the corner casting and at least partially through the pin lock aperture of the corner casting insert, until the distal end of the handle contacts the locking tab and the padlock aperture is aligned with the tab aperture of the locking tab.

In some embodiments, a corner casting pin lock is configured to be inserted through a side aperture of a corner casting and at least partially through a pin lock aperture of a corner casting insert. The corner casting pin lock includes an engagement member and a handle coupled to the engagement member. The handle includes a padlock aperture on a distal end of the handle opposite the engagement member. The corner casting pin lock is configured to be rotated by the handle, after being inserted through the side aperture of the corner casting and at least partially through the pin lock aperture of the corner casting insert, until the distal end of the handle contacts a locking tab and the padlock aperture is aligned with a tab aperture of the locking tab.

Technical advantages of certain embodiments may include systems, devices, and methods for securing corner castings using a corner casting pin lock. In particular, the disclosed embodiments provide solutions to problems with securing corner castings on large, bulky items using typical locking devices such as twist locks. When transporting large, bulky items such as wind turbine blades via rail, ship, or land vehicles, the lateral and longitudinal forces exerted on locking devices such as twist locks may exceed maximum operating specification of the locking devices. This may damage the locking devices, thereby resulting in safety hazards due to shifting and unsecured loads. Embodiments of the disclosure, however, provide a solution to these problems by providing corner casting pin locks that are easy to operate, are strong enough to handle large sheering loads that typical locking devices are unable to handle, and may be easily and visually verified as being locked by personnel. By providing corner casting pin locks according to embodiments of the disclosure, the shipping and transport operations of rail, ship, and ground vehicle shippers may be improved. As a result, the safety and reliability of shipping and transporting large, bulky items such as wind turbine blades can be increased.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the present disclosure and its advantages, reference is now made to the following descriptions taken in conjunction with the accompanying drawings, in which:

FIGS. 1A and 1B are diagrams illustrating a wind turbine blade transport system utilizing a pin locking system, according to particular embodiments.

FIGS. 2A and 2B are diagrams illustrating corner casting pin locks that may be used by the pin locking system of FIG. 1, according to particular embodiments.

FIG. 3 is a diagram illustrating the insertion of a corner casting pin lock into a corner casting, according to particular embodiments.

FIGS. 4A and 4B are diagrams illustrating the rotation of a corner casting pin lock into a closed position, according to particular embodiments.

FIG. 5 is a diagram illustrating the interaction of components of a pin locking system, according to particular embodiments.

FIG. 6 is a diagram illustrating another embodiment of a corner casting pin locks that may be used by the pin locking system of FIG. 1, according to particular embodiments.

FIG. 7 is a diagram illustrating the insertion of the corner casting pin lock of FIG. 6 into a corner casting insert, according to particular embodiments.

FIG. 8 is a diagram illustrating the rotation of the corner casting pin lock of FIG. 6 into a closed position, according to particular embodiments.

FIG. 9 is a cross-sectional view of the corner casting and corner casting pin lock of FIG. 8, according to particular embodiments.

FIGS. 10A and 10B are diagrams illustrating corner casting inserts, according to particular embodiments.

FIG. 11 is a diagram illustrating a system utilizing the corner casting insert of FIG. 10B, according to particular embodiments.

FIG. 12 is a diagram illustrating a close-up view of the corner casting and corner casting insert of FIG. 11, according to particular embodiments.

FIG. 13 is a chart illustrating a method for securing a corner casting using a corner casting pin lock, according to particular embodiments.

FIGS. 14 and 15 are diagrams illustrating additional corner casting pin locks that may be used by the pin locking system of FIG. 1, according to particular embodiments.

It should be understood that the drawings are not necessarily to scale and that the disclosed embodiments are sometimes illustrated diagrammatically and in partial views. In certain instances, details which are not necessary for an understanding of the disclosed methods and devices or which render other details difficult to perceive may have been omitted. It should be understood, of course, that this disclosure is not limited to the particular embodiments illustrated herein.

### DETAILED DESCRIPTION

The disclosure presented in the following written description and the various features and advantageous details thereof, are explained more fully with reference to the non-limiting examples included in the accompanying drawings and as detailed in the description. Descriptions of well-known components have been omitted to not unnecessarily obscure the principal features described herein. The examples used in the following description are intended to facilitate an understanding of the ways in which the disclosure can be implemented and practiced. A person of ordinary skill in the art would read this disclosure to mean that any suitable combination of the functionality or exemplary embodiments below could be combined to achieve the subject matter claimed. The disclosure includes either a representative number of species falling within the scope of the genus or structural features common to the members of the genus so that one of ordinary skill in the art can recognize the members of the genus. Accordingly, these examples should not be construed as limiting the scope of the claims.

A person of ordinary skill in the art would understand that any system claims presented herein encompass all of the elements and limitations disclosed therein, and as such, require that each system claim be viewed as a whole. Any reasonably foreseeable items functionally related to the claims are also relevant. The Examiner, after having obtained a thorough understanding of the disclosure and claims of the present application has searched the prior art as disclosed in patents and other published documents, i.e., nonpatent literature. Therefore, as evidenced by issuance of this patent, the prior art fails to disclose or teach the elements and limitations presented in the claims as enabled by the specification and drawings, such that the presented claims are patentable under the applicable laws and rules of this jurisdiction.

Corner castings are bulky metal structural objects that are used for securing large items such as shipping containers during transport. Corner castings are typically hollow, cube-shaped objects that have apertures on multiple sides that permit locking devices to be inserted into and operated within the corner casting. A typical locking device that is used to secure corner castings of objects such as shipping containers is a twist lock. Typical locking devices such as twist locks, while suitable for many applications, are not appropriate or effective for some transport applications involving corner castings.

A particular application that utilizes corner castings is the transport of wind turbine blades on railcars. In these applications, both ends of a wind turbine blade may be attached to fixtures that have multiple corner castings. The fixtures may then be secured to the railcars (e.g., using pedestals). Typically, the corner castings may be secured to the pedestals using twist locks that are commonly used in the shipping industry to secure containers. Twist locks, however, have internal spring mechanisms that may be damaged by lateral and longitudinal forces during transport on the railcars, thereby increasing the risk of failure of the twist locks and ultimately increasing the risk of an accident or a derailment. Furthermore, loading of the wind turbine blade may be such that the blade prevents the twist lock handle from rotating fully.

To address these and other problems with securing corner castings in certain applications such as railroad transport of wind turbine blades, the disclosed embodiments provide various corner casting pin locking systems and devices that may be utilized in transport applications where twist locks are unacceptable and risky. For example, a particular corner casting pin locking system includes a corner casting having a side aperture, a locking tab having a tab aperture, and a corner casting insert having a pin lock aperture. The corner casting insert is configured to be at least partially inserted into the corner casting. The corner casting pin locking system further includes a corner casting pin lock that is configured to be inserted through the side aperture of the corner casting and at least partially through the pin lock aperture of the corner casting insert. The corner casting pin lock includes an engagement member and a handle coupled to the engagement member. The handle includes a padlock aperture on a distal end of the handle opposite the engagement member. The corner casting pin lock is configured to be rotated by the handle until the distal end of the handle contacts the locking tab and the padlock aperture is aligned with the tab aperture of the locking tab. The handle may then be padlocked to the locking tab, thereby preventing the pin lock from becoming dislodged during transport and providing an easy visual indication to personnel that the pin lock is secured. Furthermore, unlike twist locks that are typically used to secure corner castings, the corner casting pin lock of the disclosed embodiments is formed from a solid durable metal (e.g., steel) that is able to withstand lateral and longitudinal forces during transport without being damaged or sheered. As a result, the transport of items such as wind turbine blades may be more secure, and accidents such as derailment may be avoided.

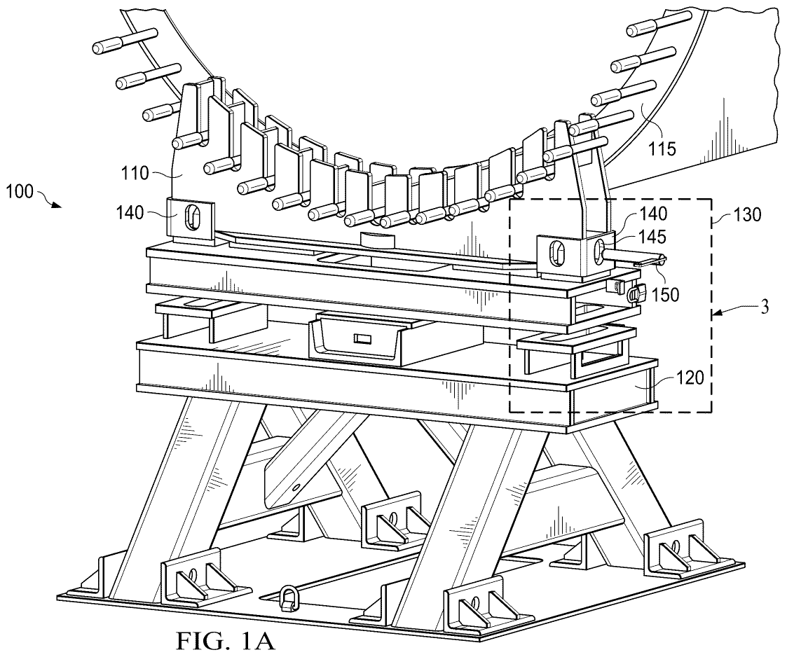

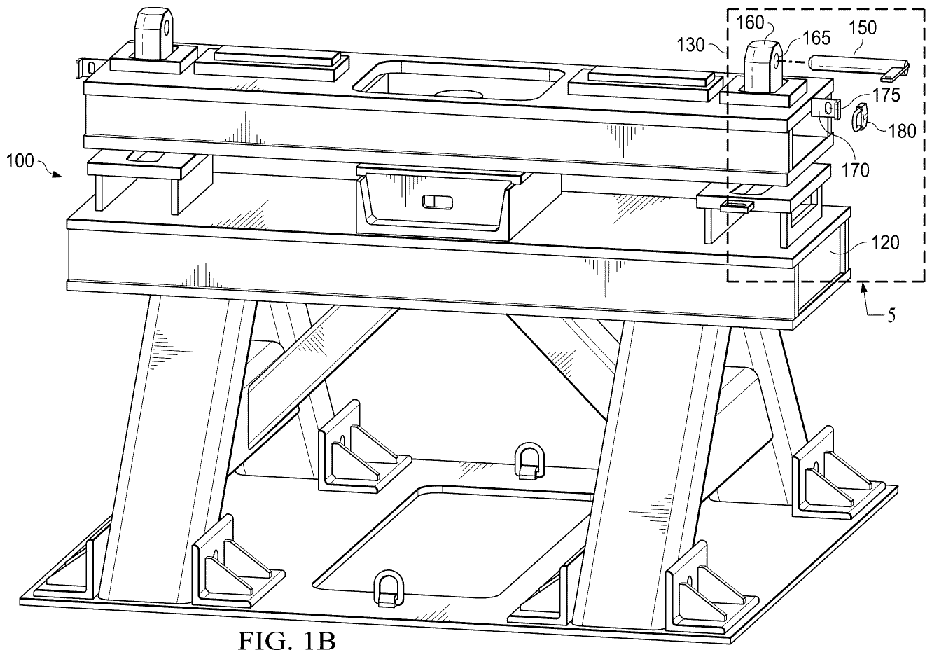

FIGS. 1A and 1B are diagrams illustrating a wind turbine blade transport system 100, according to particular embodiments. Wind turbine blade transport system 100 includes a wind turbine blade fixture 110, a pedestal 120, and a pin locking system 130. Wind turbine blade fixture 110 may be coupled to one end of a wind turbine blade 115. Wind turbine blade fixture 110 includes one or more corner castings 140 that are configured to be removably coupled to one or more corner casting inserts 160 that are attached to pedestal 120. Once corner castings 140 are lowered onto corner casting inserts 160 of pedestal 120, one or more corner casting pin locks 150 may be utilized to lock wind turbine blade fixture 110 to pedestal 120 during transport, as described in more detail below.

In general, wind turbine blade transport system 100 provides for the effective and efficient transport of wind turbine blade 115. Wind turbine blade transport system 100 may be used to transport wind turbine blade 115 via any appropriate transportation system (e.g., railway, ship, ground vehicle, etc.). To do so, each end of wind turbine blade 115 is removably attached to a wind turbine blade fixture 110. Each wind turbine blade fixture 110 includes one or more corner castings 140 (e.g., two corner castings 140 per wind turbine blade fixture 110, as illustrated). A pedestal 120 is installed on the transportation vehicle (e.g., railcar) at each end of wind turbine blade 115. Each pedestal 120 includes a corner casting insert 160 that aligns with each corner casting 140 of wind turbine blade fixture 110 (e.g., two corner casting inserts 160 per pedestal 120, as illustrated). Once wind turbine blade fixture 110 has been attached to wind turbine blade 115, wind turbine blade fixture 110 is lowered onto pedestal 120 such that each corner casting insert 160 is at least partially within its respective corner casting 140. Alternatively, wind turbine blade fixture 110 may be installed onto pedestal 120 first and then wind turbine blade 115 may be attached to turbine blade fixture 110. Once wind turbine blade fixture 110 has been installed onto pedestal 120, corner casting pin locks 150 are used to secure corner castings 140 to corner casting inserts 160 (and thereby secure wind turbine blade fixture 110 to pedestal 120). Specifically, corner casting pin lock 150 is inserted through side aperture 145 of corner casting 140 and into pin lock aperture 165 of corner casting insert 160. Corner casting pin lock 150 may then be rotated until a handle of corner casting pin lock 150 (e.g., handle 220) contacts a locking tab 170 that is attached to pedestal 120. A padlock 180 may then be installed through the handle of corner casting pin lock 150 and a tab aperture 175 of locking tab 170 in order to prevent corner casting pin lock 150 from being removed or becoming dislodged during transport. As a result, wind turbine blade fixture 110 may be securely and efficiently locked to pedestal 120, thereby ensuring the safe transport of wind turbine blade 115.

Wind turbine blade fixture 110 is any appropriate apparatus, device, or system that is configured to secure one end of wind turbine blade 115. In general, each end of wind turbine blade 115 is removably attached to a wind turbine blade fixture 110 using any appropriate fasteners or mechanism. For example, as illustrated in FIG. 1A, wind turbine blade fixture 110 may contain multiple slots or apertures that align with bolts that are installed on wind turbine blade 115. Wind turbine blade fixture 110 includes at least one corner casting 140 that is installed on or otherwise attached to a lower corner or edge of wind turbine blade fixture 110, as illustrated. In some embodiments, for example, wind turbine blade fixture 110 includes two corner castings 140 on opposite ends of wind turbine blade fixture 110. In other embodiments, however, wind turbine blade fixture 110 may have more than two corner castings 140 as needed.

Pedestal 120 is a device that is configured to removably couple to wind turbine blade fixture 110 using corner casting inserts 160. In some embodiments, pedestal 120 is a sawhorse-shaped or other shaped device as illustrated and is used to elevate an end of wind turbine blade 115 to a proper height for transport. Each pedestal 120 includes at least one corner casting insert 160 that aligns with corner casting 140 of wind turbine blade fixture 110. In some embodiments, for example, pedestal 120 includes two corner casting inserts 160 coupled to a top, flat surface of pedestal 120. In other embodiments, however, pedestal 120 may have more than two corner casting inserts 160 as needed. Corner casting inserts 160 may be coupled to pedestal 120 using any appropriate technique (e.g., welded onto pedestal 120 or fastened to pedestal 120 using fasteners such as bolts).

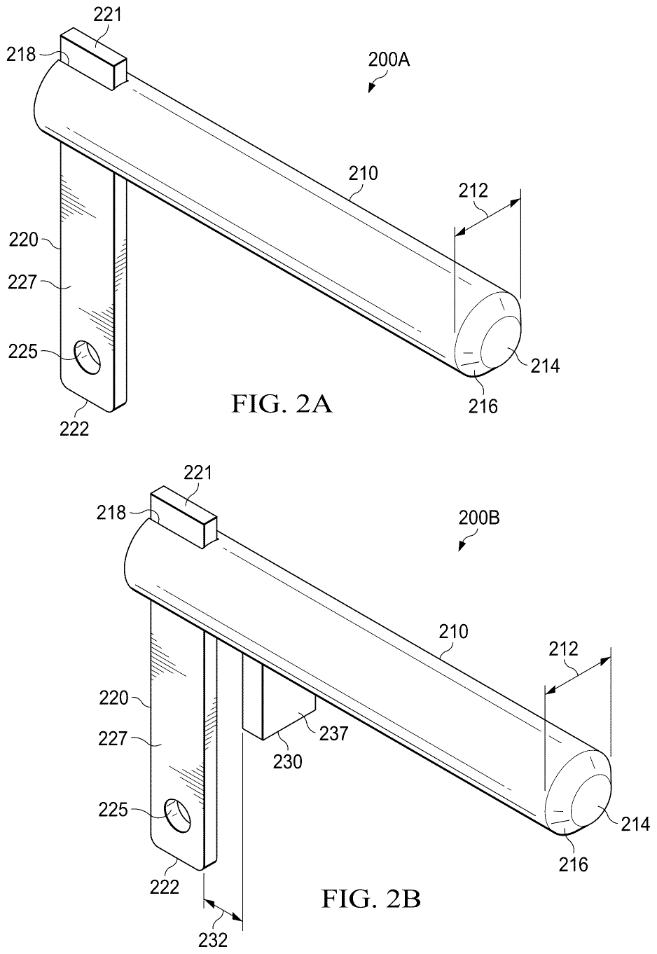

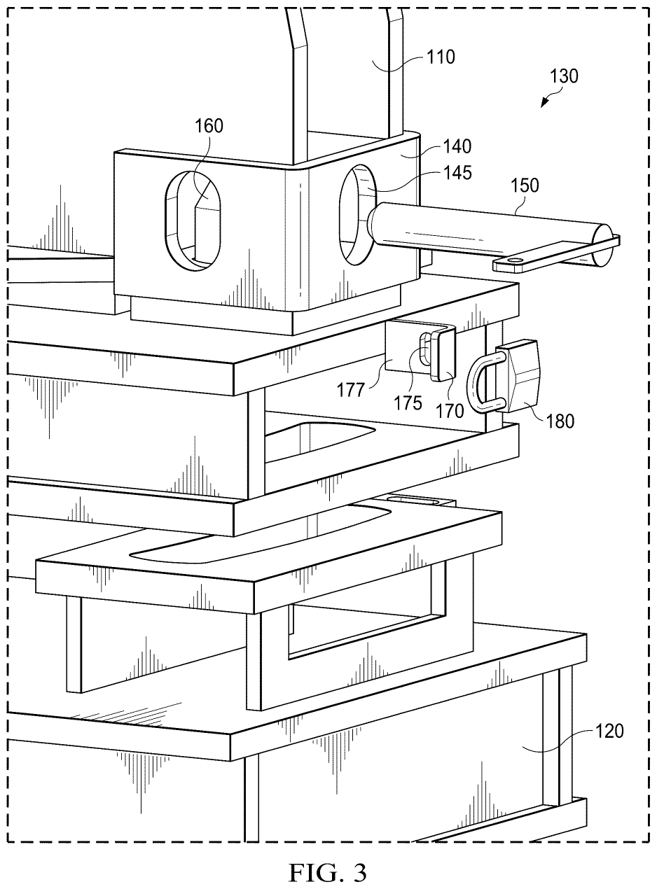

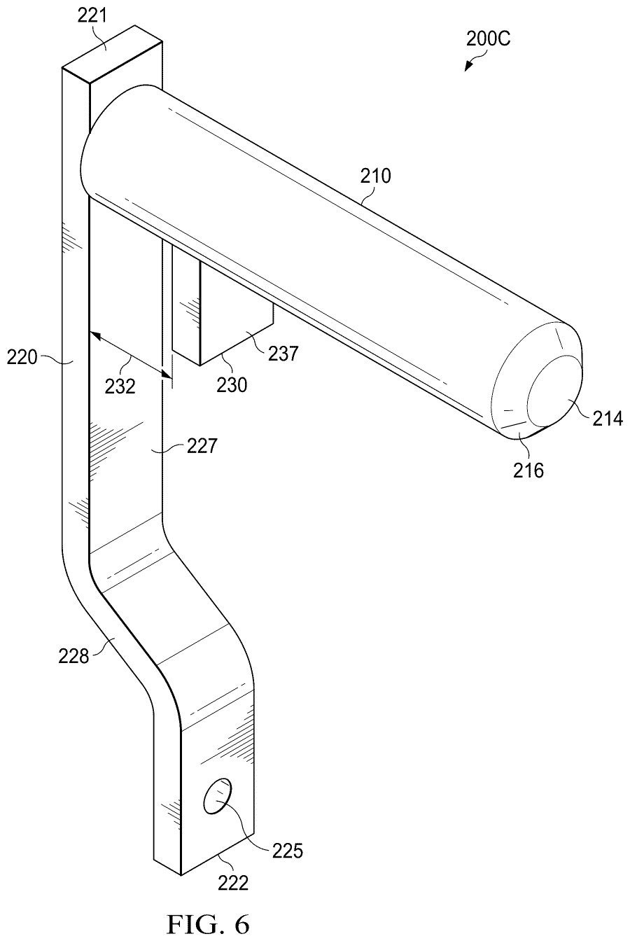

Pin locking system 130 is a system that is used to secure wind turbine blade fixture 110 to pedestal 120. Pin locking system 130 is shown in more detail in FIG. 3. In addition to corner casting 140 and corner casting insert 160, some embodiments of pin locking system 130 include a corner casting pin lock 150, a locking tab 170, and a padlock 180. Corner casting pin lock 150, as described in more detail below, is inserted through side aperture 145 of corner casting 140 and into corner casting insert 160. Locking tab 170 is mounted to pedestal 120 (e.g., welded onto pedestal 120) at a particular location as described below. Once corner casting pin lock 150 is inserted into corner casting insert 160, corner casting pin lock 150 may be rotated so that the handle of corner casting pin lock 150 (e.g., handle 220) contacts locking tab 170. Padlock 180 may then be used to secure the handle of corner casting pin lock 150 to locking tab 170. Particular embodiments of corner casting pin lock 150 are illustrated and described below in reference to FIGS. 2A, 2B, and 6.

Corner casting 140 is a hollow, cube-shaped structural object that is configured to couple to corner casting insert 160. In some embodiments, corner castings 140 are standard corner castings (e.g., ISO 1161 corner castings with dimensions of 178 mm×162 mm×118mm) that are installed on the corners of shipping containers. In some embodiments, corner castings 140 are made of metal (e.g., cast steel). Each corner casting 140 includes an aperture on the top/bottom surface that allows corner casting insert 160 to be inserted into corner casting 140. In addition, each corner casting 140 includes at least one side aperture 145, as illustrated. Side aperture 145 is any appropriate shape and has any appropriate dimensions that allow corner casting pin lock 150 to be inserted into corner casting insert 160. In some embodiments, side aperture 145 is a stadium shape (also known as a pill shape or a disco rectangle shape).

Corner casting pin lock 150 is a device that is configured to be inserted through side aperture 145 of corner casting 140 and at least partially through pin lock aperture 165 of corner casting insert 160 in order to secure wind turbine blade fixture 110 to pedestal 120. In general, corner casting pin lock 150 replaces devices such as twist locks that are typically used to secure corner castings 140 during transport. Twist locks have internal mechanisms (e.g., springs, etc.) that are prone to damage from certain forces (e.g., lateral and longitudinal forces) that are present when transporting large objects such as wind turbine blade 115. Corner casting pin lock 150, however, is a solid metal object (e.g., steel) that is more capable of handling the lateral, longitudinal, and vertical forces from transporting objects such as wind turbine blade 115. Certain embodiments of corner casting pin lock 150 are discussed in more detail below in reference to FIGS. 2A, 2B, and 6.

FIG. 2A is a diagram illustrating a corner casting pin lock 200A that may be used as corner casting pin lock 150 by wind turbine blade transport system 100 of FIG. 1, according to particular embodiments. In some embodiments, corner casting pin lock 200A includes an engagement member 210 and a handle 220. In general, engagement member 210 is inserted into pin lock aperture 165 of corner casting insert 160 to secure corner casting 140 to corner casting insert 160. Handle 220 is used to insert engagement member 210 into corner casting insert 160 and to rotate corner casting pin lock 200A to a locking position (e.g., to a position where handle 220 can be padlocked to locking tab 170).

In some embodiments, engagement member 210 has a shape of an elongated cylinder, as illustrated. In some embodiments, engagement member 210 has an end 214 that is opposite handle 220. In some embodiments, end 214 may have any appropriate shape. For example, end 214 may be rounded, pointed, or flat. In some embodiments, end 214 has a chamfered edge 216, as illustrated.

In some embodiments, engagement member 210 includes a diameter 212 that is smaller than a diameter of pin lock aperture 165 of corner casting insert 160 such that engagement member 210 contacts corner casting insert 160 as engagement member 210 is inserted through pin lock aperture 165. In some embodiments, diameter 212 is sized in order to prevent shearing of engagement member 210. For example, diameter 212 may be sized in order to prevent shearing based on the weight of wind turbine blade 115 or the transport vehicle (e.g., the railcar).

In some embodiments, engagement member 210 includes a handle notch 218 that is opposite end 214. In some embodiments, handle notch 218 may have dimensions that correspond to handle 220. In general, handle notch 218 permits handle 220 to be coupled to engagement member 210 (e.g., either removably coupled or permanently coupled).

Handle 220 may have any appropriate shape that allows a user to insert corner casting pin lock 200A into corner casting insert 160 and then rotate corner casting pin lock 200A to a locking position. In some embodiments, handle 220 is a flat bar. Handle 220 may be coupled to engagement member 210 using any appropriate technique. For example, handle 220 may be welded to engagement member 210. In other embodiments, handle 220 may be removably coupled to engagement member 210 (e.g., within handle notch 218). In some embodiments, handle 220 is coupled to engagement member 210 using one or more fasteners such as bolts. In some embodiments, handle 220 is orthogonally coupled to engagement member 210. In these embodiments, flat faces 227 of handle 220 are orthogonal to ends of engagement member 210 (e.g., end 214). In other embodiments, handle 220 is coupled to engagement member 210 at any appropriate angle.

In some embodiments, handle 220 includes a padlock aperture 225 that enables corner casting pin lock 200A to be padlocked to locking tab 170. Padlock aperture 225 may have any appropriate shape (e.g., circular) and may have any appropriate dimensions that allow corner casting pin lock 200A to be padlocked to locking tab 170 using padlock 180. In general, padlock aperture 225 is located proximate a distal end 222 of handle 220 that is opposite engagement member 210 (i.e., opposite engagement member end 221).

FIG. 2B is a diagram illustrating a corner casting pin lock 200B that may be used as corner casting pin lock 150 by wind turbine blade transport system 100 of FIG. 1, according to particular embodiments. Similar to corner casting pin lock 200A, some embodiments of corner casting pin lock 200B include an engagement member 210 and a handle 220. Additionally, however, corner casting pin lock 200B includes a locking member 230 coupled to engagement member 210. In general, locking member 230 provides an additional mechanism to prevent corner casting pin lock 200B from being removed or from becoming dislodged from corner casting insert 160 after corner casting pin lock 200B has been rotated to its locking position.

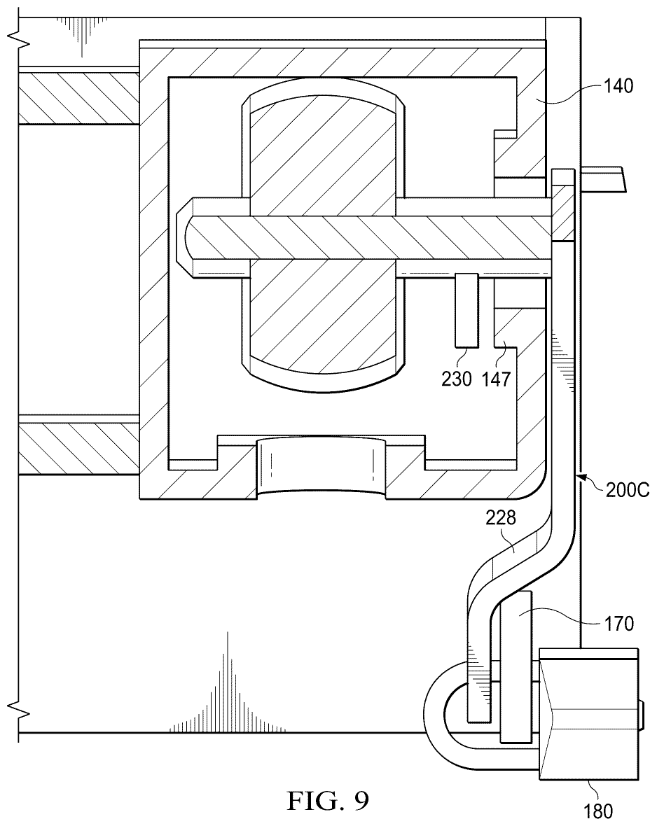

In some embodiments, locking member 230 is coupled to engagement member 210 using any appropriate technique. For example, locking member 230 may be welded to engagement member 210. In other embodiments, locking member 230 may be removably coupled to engagement member 210 using one or more fasteners such as bolts. In some embodiments, locking member 230 is coupled to engagement member 210 a predetermined distance 232 away from handle 220. Predetermined distance 232 may be based on the dimensions of corner casting 140, corner casting insert 160, and corner casting pin lock 200B. For example, predetermined distance 232 may be a distance that allows locking member 230 to contact or otherwise be proximate to an inner surface of corner casting 140 (e.g., inner surface 147 of FIG. 9) when engagement member 210 is fully inserted into pin lock aperture 165 of corner casting insert 160.

In some embodiments, locking member 230 is a flat bar with flat faces 237. In some embodiments, flat faces 237 of locking member 230 are orthogonal to flat faces 227 of handle 220 as illustrated in FIG. 2B. In some embodiments, locking member 230 is shorter than handle 220. In general, locking member 230 has a shape and dimensions that allow locking member 230 to pass through side aperture 145 of corner casting 140 as engagement member 210 of corner casting pin lock 200B is inserted into pin lock aperture 165 of corner casting insert 160.

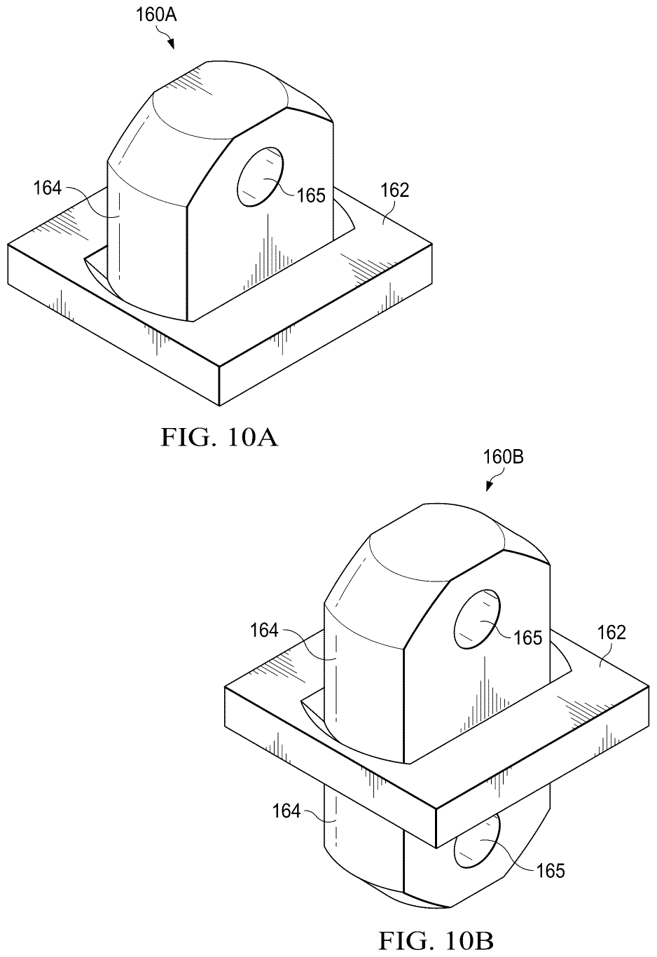

Corner casting insert 160 is a structural object that is configured to be at least partially inserted into corner casting 140 (e.g., corner casting 140 of wind turbine blade fixture 110). In general, corner casting insert 160 is the main structural object that is used along with corner casting pin lock 150 to secure corner casting 140. In some embodiments, corner casting insert 160 is formed from metal (e.g., steel). Particular embodiments of corner casting insert 160 are show in more detail in FIGS. 10A and 10B.

Corner casting insert 160 includes a base 162, a protrusion 164, and a pin lock aperture 165. In some embodiments, base 162 is square or rectangular in shape as illustrated and is used to secure corner casting insert 160 (e.g., via welding) to another object such as pedestal 120. Protrusion 164 may have any appropriate shape and dimensions that correspond to the inner chamber of corner casting 140. In some embodiments, for example, protrusion 164 may be tubular in shape except with two opposite flat sides as illustrated. In addition, protrusion 164 may have a chamfered top edge as illustrated. Pin lock aperture 165 is an aperture within protrusion 164 for engagement member 210 of corner casting pin lock 150. In some embodiments, pin lock aperture 165 is cylindrical in shape as illustrated and has a diameter that is slightly larger than engagement member 210 of corner casting pin lock 150.

Locking tab 170 is a structural component that is used to lock corner casting pin lock 150 to pedestal 120 using padlock 180. In some embodiments, locking tab 170 is a completely flat bar. In other embodiments, locking tab 170 is a flat bar with a lip 172 that forms a surface that is orthogonal to the main surface of locking tab 170, as illustrated in FIG. 3. Locking tab 170 includes a tab aperture 175 that is used to secure corner casting pin lock 150 using padlock 180. Tab aperture 175 may be any appropriate shape and dimensions in order to permit the operation of padlock 180.

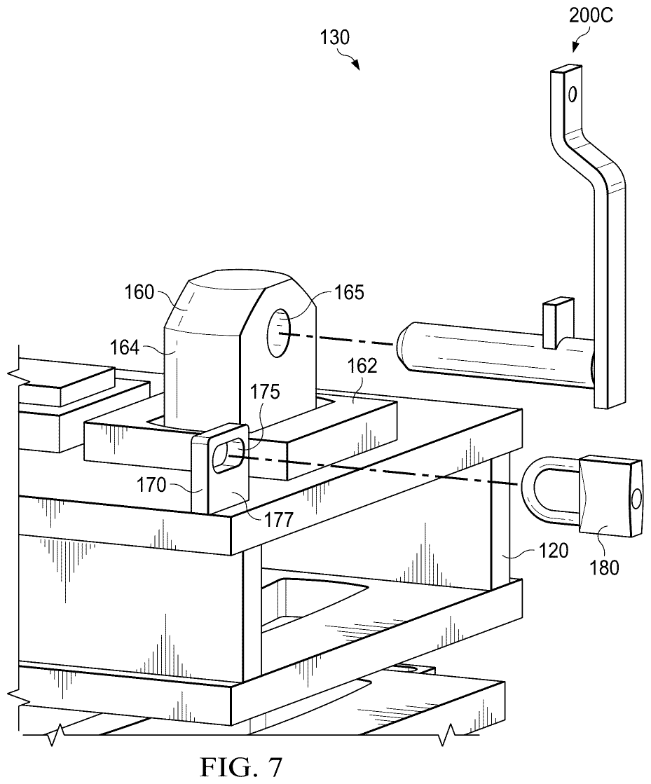

In some embodiments, locking tab 170 is coupled to pedestal 120 via welding. In other embodiments, locking tab 170 is coupled to pedestal 120 using any appropriate fasteners such a bolts. Locking tab 170 may be coupled to pedestal 120 at any appropriate location and position according to the particular corner casting pin lock 150 that is utilized in pin locking system 130. As a first example, if corner casting pin lock 200A is used in pin locking system 130, locking tab 170 may be coupled to pedestal 120 in a position as best illustrated in FIG. 3. In these embodiments, locking tab 170 is coupled to pedestal 120 below corner casting insert 160 at a distance that corresponds to the length of handle 220 (i.e., at a position where padlock aperture 225 aligns with tab aperture 175 when corner casting pin lock 200A is rotated to the locked position). In addition, flat faces 177 of locking tab 170 are parallel with flat faces 227 of handle 220 when corner casting pin lock 200A is rotated to the locked position. As another example, if corner casting pin lock 200C is used in pin locking system 130, locking tab 170 may be coupled to pedestal 120 in a position as best illustrated in FIG. 7. In these embodiments, locking tab 170 is coupled to pedestal 120 on the same surface as corner casting insert 160 and at a distance away from corner casting insert 160 that corresponds to the length of handle 220 (i.e., at a position where padlock aperture 225 aligns with tab aperture 175 when corner casting pin lock 200C is rotated to the locked position). In addition, flat faces 177 of locking tab 170 are parallel with flat faces 227 of handle 220 when corner casting pin lock 200C is rotated to the locked position.

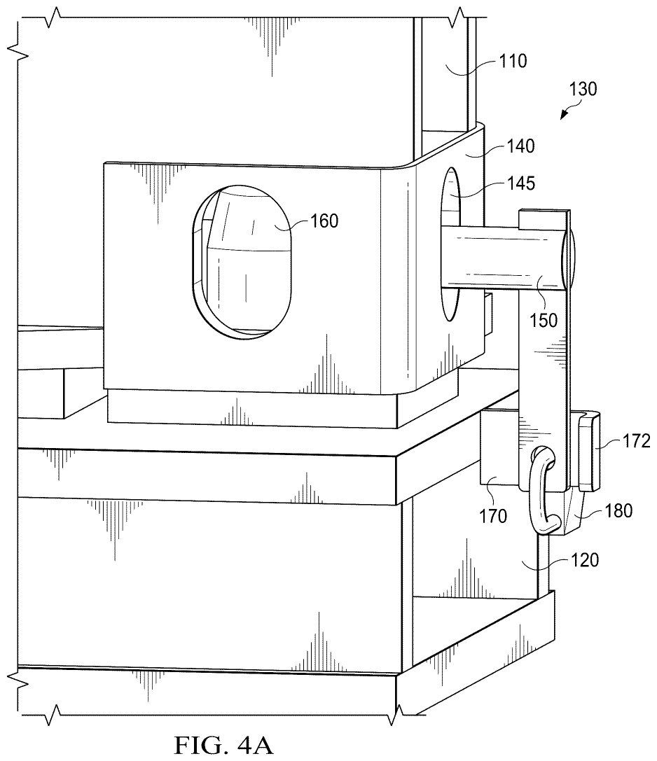

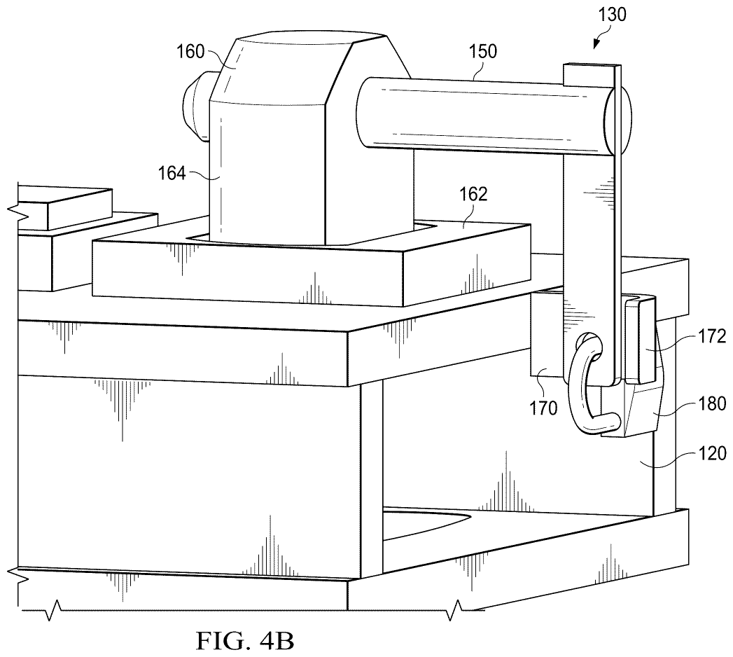

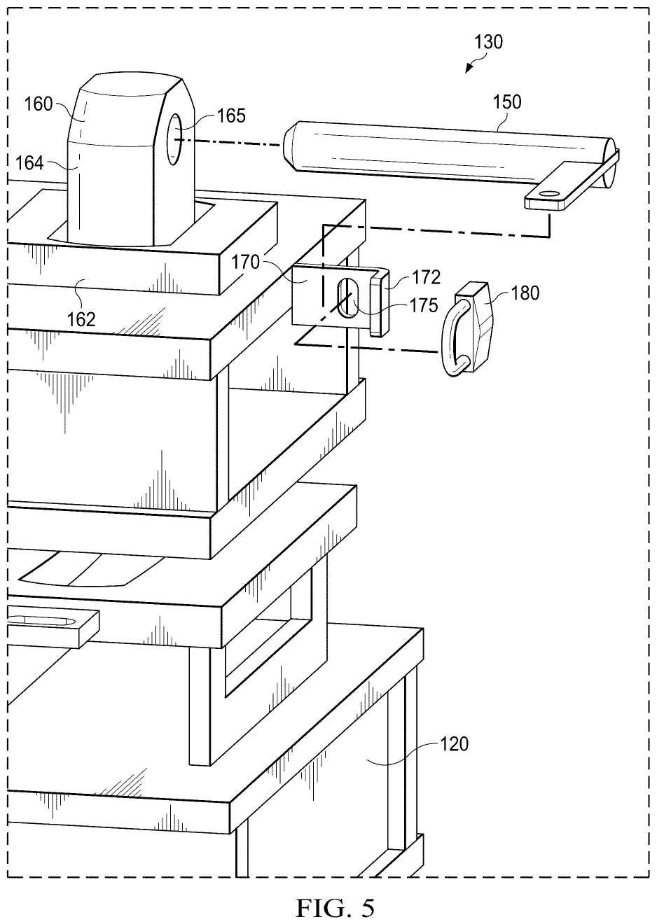

In operation, and in reference to FIGS. 3, 4A, 4B, and 5, pin locking system 130 may be used to secure corner casting 140 to corner casting insert 160 (e.g., in order to secure wind turbine blade fixture 110 to pedestal 120 as illustrated in FIGS. 1A and 1B). First, corner casting 140 is installed onto corner casting insert 160 such that protrusion 164 is within corner casting 140. Once corner casting 140 has been installed onto corner casting insert 160, corner casting pin lock 150 (e.g., corner casting pin lock 200A or corner casting pin lock 200B as illustrated in FIGS. 2A and 2B) is used to secure corner casting 140 to corner casting insert 160. Specifically, corner casting pin lock 150 is inserted through side aperture 145 of corner casting 140 and into pin lock aperture 165 of corner casting insert 160 as illustrated in FIG. 3. Corner casting pin lock 150 may then be rotated until handle 220 contacts locking tab 170 (i.e., the locking position as illustrated in FIGS. 4A and 4B). Padlock 180 may then be installed through padlock aperture 225 of handle 220 and tab aperture 175 of locking tab 170 in order to prevent corner casting pin lock 150 from being removed or becoming dislodged from corner casting insert 160 during transport. As a result, corner casting 140 may be securely and efficiently locked to corner casting insert 160, thereby ensuring the safe transport of objects such as wind turbine blade 115.

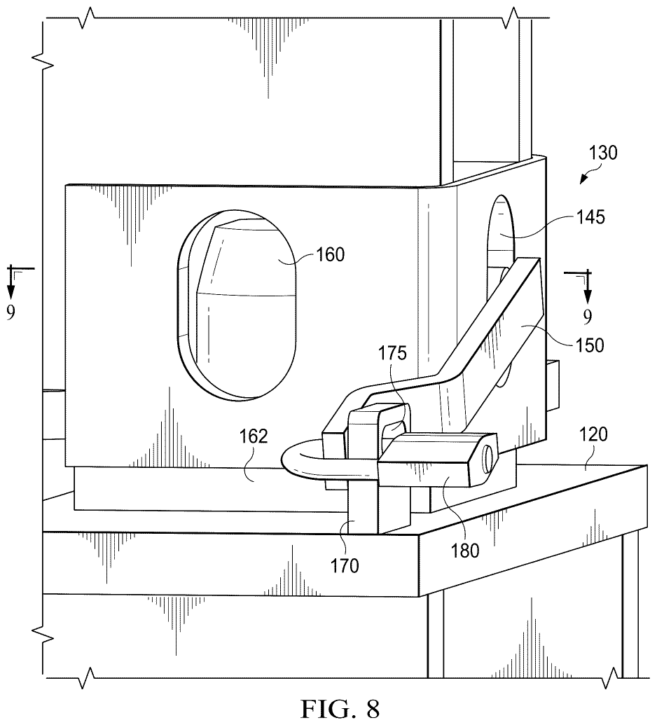

FIGS. 6 and 7 are diagrams illustrating a corner casting pin lock 200C that may be used as corner casting pin lock 150 by wind turbine blade transport system 100 of FIG. 1, according to particular embodiments. Similar to corner casting pin locks 200A and 200B, some embodiments of corner casting pin lock 200C include an engagement member 210 and a handle 220. However, handle 220 of corner casting pin lock 200C is coupled to an end of engagement member 210 that is opposite end 214, as illustrated. That is, flat faces 227 of handle 220 are parallel to the ends of engagement member 210 (e.g., end 214). Handle 220 may be coupled to engagement member 210 in these embodiments using any appropriate technique (e.g., via welding, with fasteners such as bolts, etc.). Additionally, handle 220 of corner casting pin lock 200C includes a bend 228 within handle 220, as illustrated. Bend 228 enables an outside flat surface of distal end 222 of handle 220 to contact locking tab 170 as illustrated in FIGS. 8 and 9, thereby preventing corner casting pin lock 200C from backing out of corner casting insert 160 during transport.

In some embodiments, corner casting pin lock 200C, similar to corner casting pin lock 200B, includes a locking member 230 coupled to engagement member 210. Locking member 230 is coupled to engagement member 210 of corner casting pin lock 200C using any appropriate technique. For example, locking member 230 may be welded to engagement member 210. In other embodiments, locking member 230 may be removably coupled to engagement member 210 using one or more fasteners such as bolts. In some embodiments, locking member 230 is coupled to engagement member 210 a predetermined distance 232 away from handle 220. Predetermined distance 232 may be based on the dimensions of corner casting 140, corner casting insert 160, and corner casting pin lock 200C. For example, predetermined distance 232 may be a distance that allows locking member 230 to contact or otherwise be proximate to inner surface 147 of corner casting 140 as illustrated in the cutaway view of FIG. 9 when engagement member 210 is fully inserted into pin lock aperture 165 of corner casting insert 160. As illustrated in FIG. 6, flat faces 237 of locking member 230 are parallel to flat faces 227 of handle 220 in some embodiments of corner casting pin lock 200C.

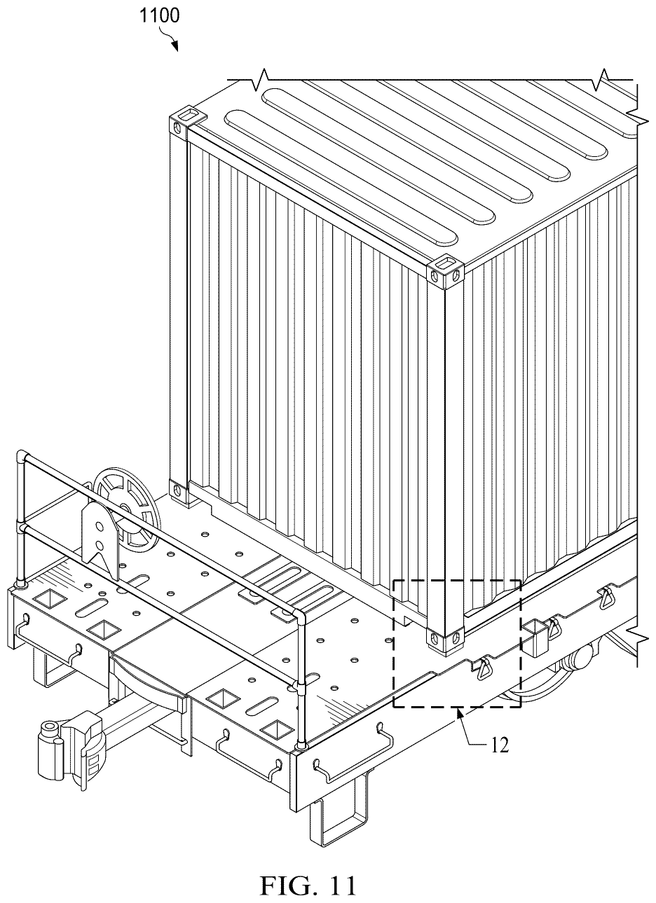

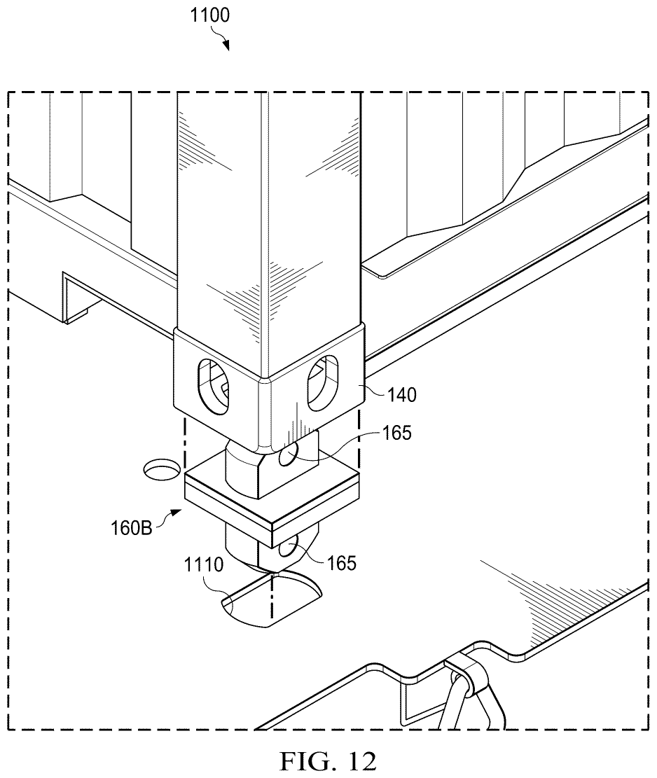

FIGS. 10A and 10B are diagrams illustrating corner casting inserts 160A and 160B, according to particular embodiments. As described above, corner casting inserts 160A and 160B each include a base 162, at least one protrusion 164, and a pin lock aperture 165 through each protrusion 164. Corner casting insert 160A includes a single protrusion 164 attached to one side of base 162, while corner casting insert 160B includes two protrusions 164 that are coupled to opposite faces of base 162, as illustrated. In some embodiments, corner casting insert 160A may be used in applications such as wind turbine blade transport system 100 where corner casting insert 160A may be welded to an object such as pedestal 120. Corner casting inserts 160A and/or 160B may be used in applications such as system 1100 that is illustrated in FIGS. 11 and 12. In embodiments such as system 1100, corner casting insert 160B is not permanently welded to an object such as pedestal 120. Instead, a mounting aperture 1110 is formed in an object that corner casting 140 is to be coupled. In this illustrated embodiment, corner casting 140 is to be temporarily coupled to a railcar using mounting aperture 1110 that is formed in the railcar. One protrusion 164 of corner casting insert 160B is placed into mounting aperture 1110 and is secured using, for example, a corner casting pin lock 150 as described herein (e.g., using a locking tab 170 and a padlock 180 that are not illustrated in FIGS. 11-12). Corner casting 140 is then placed over the opposite protrusion 164 of corner casting insert 160B and is secured in place using, for example, corner casting pin lock 150 as described herein (e.g., using a locking tab 170 and a padlock 180 that are not illustrated in FIGS. 11-12). As a result, items such as shipping containers having corner castings 140 can be removably secured to transportation vehicles such as railcars, boats, and road vehicles. In some embodiments, corner casting insert 160A may be used in lieu of corner casting insert 160B as described in reference to FIGS. 11-12, however corner casting insert 160A may be welded to the railcar and not placed over a mounting aperture.

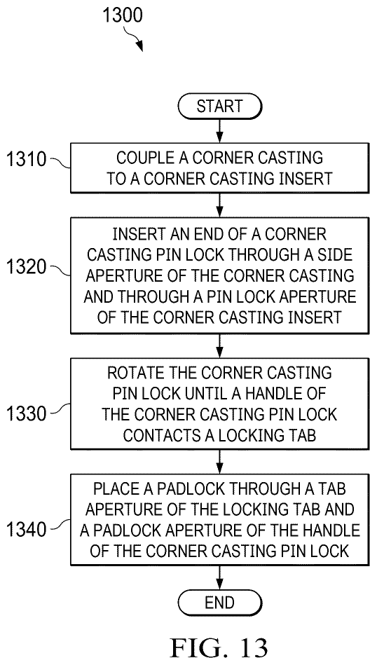

FIG. 13 is a chart illustrating a method 1300 for securing corner castings using a corner casting pin lock device, according to particular embodiments. At step 1310, a corner casting is coupled to a corner casting insert. In some embodiments, the corner casting is corner casting 140. In some embodiments, the corner casting insert is corner casting insert 160. In some embodiments, the corner casting is placed over the corner casting insert such that a protrusion of the corner casting insert is within the corner casting.

At step 1320, an end of a corner casting pin lock is inserted through a side aperture of the corner casting and through a pin lock aperture of the corner casting insert. In some embodiments, the corner casting pin lock is corner casting pin lock 150 (e.g., corner casting pin lock 200A, 200B, or 200C). In some embodiments, the end of the corner casting pin lock is end 214. In some embodiments, the side aperture of the corner casting is side aperture 145. In some embodiments, the pin lock aperture is pin lock aperture 165.

At step 1330, the corner casting pin lock is rotated until a handle of the corner casting pin lock contacts a locking tab. In some embodiments, the handle is handle 220 of corner casting pin lock 200A, 200B, or 200C. In some embodiments, the locking tab is locking tab 170. In some embodiments, step 1330 additionally or alternately includes aligning a padlock aperture of the handle (e.g., padlock aperture 225) with a tab aperture of the locking tab.

At step 1330, a padlock is placed through a tab aperture of the locking tab and a padlock aperture of the handle of the corner casting pin lock. In some embodiments, the padlock is padlock 180. After step 1330, method 1300 may end.

Particular embodiments may repeat one or more steps of the method of FIG. 13, where appropriate. Although this disclosure describes and illustrates particular steps of the method of FIG. 13 as occurring in a particular order, this disclosure contemplates any suitable steps of the method of FIG. 13 occurring in any suitable order. Moreover, although this disclosure describes and illustrates an example method including the particular steps of the method of FIG. 13, this disclosure contemplates any suitable method including any suitable steps, which may include all, some, or none of the steps of the method of FIG. 13, where appropriate. Furthermore, although this disclosure describes and illustrates particular components, devices, or systems carrying out particular steps of the method of FIG. 13, this disclosure contemplates any suitable combination of any suitable components, devices, or systems carrying out any suitable steps of the method of FIG. 13.

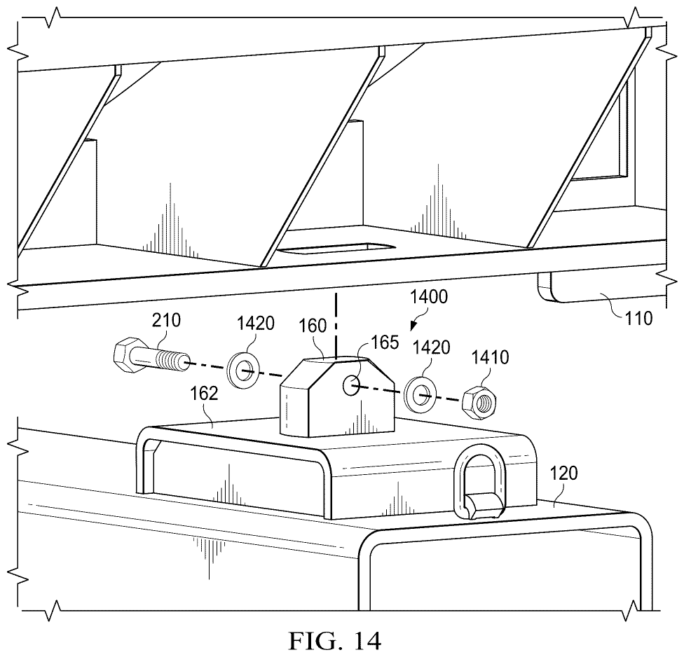

FIG. 14 is a diagram illustrating a corner casting pin lock 1400 that may be used as corner casting pin lock 150 by wind turbine blade transport system 100 of FIG. 1, according to particular embodiments. In some embodiments, corner casting pin lock 1400 includes an engagement member 210 that is a bolt in this embodiment. In general, corner casting pin lock 1400 is inserted through pin lock aperture 165 of corner casting insert 160 after corner casting insert 160 is inserted through an aperture in fixture 110. In some embodiments, engagement member 210 is secured in place and prevented from being removed by a nut 1410. In some embodiments, washers 1420 may be placed on engagement member 210 on both sides of corner casting insert 160 as illustrated.

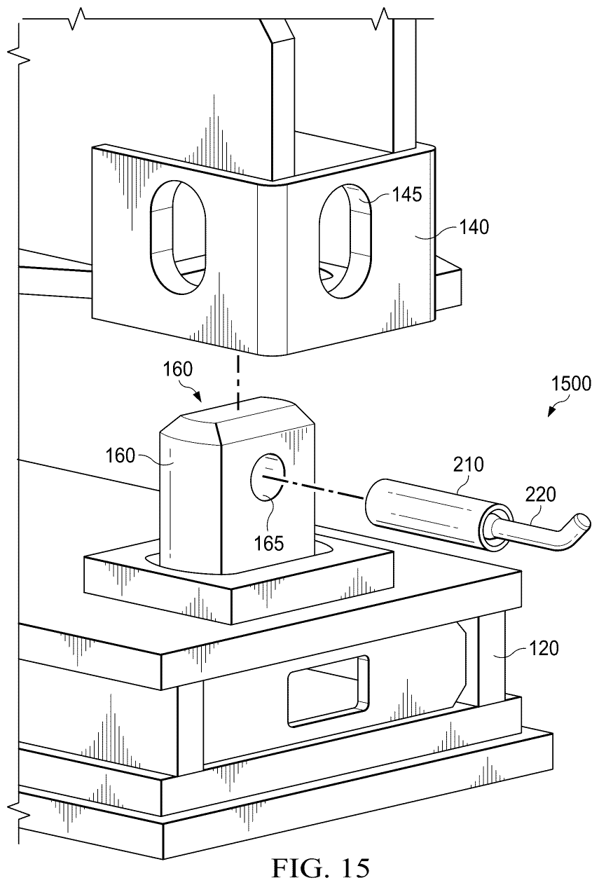

FIG. 15 is a diagram illustrating a corner casting pin lock 1500 that may be used as corner casting pin lock 150 by wind turbine blade transport system 100 of FIG. 1, according to particular embodiments. In some embodiments, corner casting pin lock 1400 includes an engagement member 210 and a handle 220 as illustrated. In general, engagement member 210 is inserted into pin lock aperture 165 of corner casting insert 160 to secure corner casting 140 to corner casting insert 160. Handle 220 is used to insert engagement member 210 into corner casting insert 160. Handle 220 may have any appropriate shape that allows a user to insert corner casting pin lock 1500 into corner casting insert 160. In some embodiments, handle 220 is a rod that is straight or with a bend as illustrated. Handle 220 may be coupled to engagement member 210 using any appropriate technique. For example, handle 220 may be welded to engagement member 210. In other embodiments, handle 220 may be removably coupled to engagement member 210 (e.g., via a fastener such as a bolt).

Although the present disclosure and its advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present disclosure, processes, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

Moreover, the description in this patent document should not be read as implying that any particular element, step, or function can be an essential or critical element that must be included in the claim scope. Also, none of the claims can be intended to invoke 35 U.S.C. § 112(f) with respect to any of the appended claims or claim elements unless the exact words “means for” or “step for” are explicitly used in the particular claim, followed by a participle phrase identifying a function. Use of terms such as (but not limited to) “member,” “module,” “device,” “unit,” “component,” “element,” “mechanism,” “apparatus,” “machine,” “system,” “processor,” “processing device,” or “controller” within a claim can be understood and intended to refer to structures known to those skilled in the relevant art, as further modified or enhanced by the features of the claims themselves, and can be not intended to invoke 35 U.S.C. § 112(f). Even under the broadest reasonable interpretation, in light of this paragraph of this specification, the claims are not intended to invoke 35 U.S.C. § 112(f) absent the specific language described above.

While the include figures illustrate particular embodiments having particular components, this disclosure contemplates other embodiments having some or all of the described components, as well as additional components not described. Components of the present disclosure may be any suitable shape and may be in any suitable configuration.

As used in this document, “each” refers to each member of a set or each member of a subset of a set. Furthermore, as used in the document “or” is not necessarily exclusive and, unless expressly indicated otherwise, can be inclusive in certain embodiments and can be understood to mean “and/or.” Similarly, as used in this document “and” is not necessarily inclusive and, unless expressly indicated otherwise, can be inclusive in certain embodiments and can be understood to mean “and/or.”

The disclosure may be embodied in other specific forms without departing from the spirit or essential characteristics thereof. For example, each of the new structures described herein, may be modified to suit particular local variations or requirements while retaining their basic configurations or structural relationships with each other or while performing the same or similar functions described herein. The present embodiments are therefore to be considered in all respects as illustrative and not restrictive. Accordingly, the scope of the disclosures can be established by the appended claims rather than by the foregoing description. All changes which come within the meaning and range of equivalency of the claims are therefore intended to be embraced therein. Further, the individual elements of the claims are not well-understood, routine, or conventional. Instead, the claims are directed to the unconventional inventive concept described in the specification.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, functions, operations, or steps, any of these embodiments may include any combination or permutation of any of the components, elements, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative.

1. A wind turbine blade transport system comprising:
a turbine blade fixture configured to secure one end of a turbine blade, the turbine blade fixture comprising a corner casting, the corner casting comprising a side aperture;
a pedestal configured to removably couple to the turbine blade fixture, the pedestal comprising:
a locking tab comprising a tab aperture; and
a corner casting insert configured to be at least partially inserted into the corner casting of the turbine blade fixture as the turbine blade fixture is lowered onto the pedestal, the corner casting insert comprising a pin lock aperture; and
a corner casting pin lock configured to be inserted through the side aperture of the corner casting and at least partially through the pin lock aperture of the corner casting insert, the corner casting pin lock comprising:
an engagement member; and
a handle coupled orthogonally to the engagement member, the handle comprising a padlock aperture on a distal end of the handle opposite the engagement member;
wherein the corner casting pin lock is configured to be rotated by the handle, after being inserted through the side aperture of the corner casting and at least partially through the pin lock aperture of the corner casting insert, until the distal end of the handle contacts the locking tab and the padlock aperture is aligned with the tab aperture of the locking tab.

2. The wind turbine blade transport system of claim 1, wherein:
the engagement member of the corner casting pin lock has a shape of an elongated cylinder;
the pin lock aperture of the corner casting insert is cylindrical in shape; and
the engagement member comprises a diameter that is smaller than a diameter of the pin lock aperture such that the engagement member contacts the corner casting insert as the engagement member is inserted through the pin lock aperture.

3. The wind turbine blade transport system of claim 2, wherein the diameter of the engagement member is sized in order to prevent shearing of the engagement member when the turbine blade is lifted.

4. The wind turbine blade transport system of claim 1, wherein:
the engagement member of the corner casting pin lock has a shape of an elongated cylinder;
an end of the engagement member that is opposite the handle comprises a chamfered edge; and
the handle is a flat bar.

5. The wind turbine blade transport system of claim 1, wherein the corner casting pin lock further comprises a locking member coupled to the engagement member a predetermined distance away from the handle, the locking member configured to:
pass through the side aperture of the corner casting as the corner casting pin lock is at least partially inserted through the pin lock aperture of the corner casting insert; and
contact an inner surface of the corner casting when the corner casting pin lock is rotated by the handle, thereby preventing the corner casting pin lock from backing out of the pin lock aperture of the corner casting insert during transport.

6. The wind turbine blade transport system of claim 5, wherein:
the handle is a flat bar;
the locking member is a flat bar;
the locking member is shorter than the handle; and
flat faces of the handle are orthogonal to flat faces of the locking member.

7. The wind turbine blade transport system of claim 1, wherein the handle comprises a bend that enables an outside flat surface of the distal end of the handle to contact the locking tab, thereby preventing the corner casting pin lock from backing out of the pin lock aperture of the corner casting insert during transport.

8. A corner casting pin locking system comprising:
a corner casting comprising a side aperture;
a locking tab comprising a tab aperture;
a corner casting insert configured to be at least partially inserted into the corner casting as the corner casting is lowered onto the corner casting insert, the corner casting insert comprising a pin lock aperture; and
a corner casting pin lock configured to be inserted through the side aperture of the corner casting and at least partially through the pin lock aperture of the corner casting insert, the corner casting pin lock comprising:
an engagement member; and
a handle coupled to the engagement member, the handle comprising a padlock aperture on a distal end of the handle opposite the engagement member;
wherein the corner casting pin lock is configured to be rotated by the handle, after being inserted through the side aperture of the corner casting and at least partially through the pin lock aperture of the corner casting insert, until the distal end of the handle contacts the locking tab and the padlock aperture is aligned with the tab aperture of the locking tab.

9. The corner casting pin locking system of claim 8, wherein:
the engagement member of the corner casting pin lock has a shape of an elongated cylinder;
the pin lock aperture of the corner casting insert is cylindrical in shape; and
the engagement member comprises a diameter that is smaller than a diameter of the pin lock aperture such that the engagement member contacts the corner casting insert as the engagement member is inserted through the pin lock aperture.

10. The corner casting pin locking system of claim 9, wherein the diameter of the engagement member is sized in order to prevent shearing of the engagement member.

11. The corner casting pin locking system of claim 8, wherein:
the engagement member of the corner casting pin lock has a shape of an elongated cylinder;
an end of the engagement member that is opposite the handle comprises a chamfered edge; and
the handle is a flat bar.

12. The corner casting pin locking system of claim 8, wherein the corner casting pin lock further comprises a locking member coupled to the engagement member a predetermined distance away from the handle, the locking member configured to:
pass through the side aperture of the corner casting as the corner casting pin lock is at least partially inserted through the pin lock aperture of the corner casting insert; and
contact an inner surface of the corner casting when the corner casting pin lock is rotated by the handle, thereby preventing the corner casting pin lock from backing out of the pin lock aperture of the corner casting insert during transport.

13. The corner casting pin locking system of claim 12, wherein:
the handle is a flat bar;
the locking member is a flat bar;
the locking member is shorter than the handle; and
flat faces of the handle are orthogonal to flat faces of the locking member.

14. The corner casting pin locking system of claim 8, wherein the handle comprises a bend that enables an outside flat surface of the distal end of the handle to contact the locking tab, thereby preventing the corner casting pin lock from backing out of the pin lock aperture of the corner casting insert during transport.

15. A corner casting pin lock configured to be inserted through a side aperture of a corner casting and at least partially through a pin lock aperture of a corner casting insert, the corner casting pin lock comprising:
an engagement member; and
a handle coupled to the engagement member, the handle comprising a padlock aperture on a distal end of the handle opposite the engagement member;
wherein the corner casting pin lock is configured to be rotated by the handle, after being inserted through the side aperture of the corner casting and at least partially through the pin lock aperture of the corner casting insert, until the distal end of the handle contacts a locking tab and the padlock aperture is aligned with a tab aperture of the locking tab.

16. The corner casting pin lock of claim 15, wherein:
the engagement member of the corner casting pin lock has a shape of an elongated cylinder;
the pin lock aperture of the corner casting insert is cylindrical in shape; and
the engagement member comprises a diameter that is smaller than a diameter of the pin lock aperture such that the engagement member contacts the corner casting insert as the engagement member is inserted through the pin lock aperture.

17. The corner casting pin lock of claim 16, wherein the diameter of the engagement member is sized in order to prevent shearing of the engagement member.

18. The corner casting pin lock of claim 15, wherein:
the engagement member of the corner casting pin lock has a shape of an elongated cylinder;
an end of the engagement member that is opposite the handle comprises a chamfered edge; and
the handle is a flat bar.

19. The corner casting pin lock of claim 15, wherein the corner casting pin lock further comprises a locking member coupled to the engagement member a predetermined distance away from the handle, the locking member configured to:
pass through the side aperture of the corner casting as the corner casting pin lock is at least partially inserted through the pin lock aperture of the corner casting insert; and
contact an inner surface of the corner casting when the corner casting pin lock is rotated by the handle, thereby preventing the corner casting pin lock from backing out of the pin lock aperture of the corner casting insert during transport;
wherein:
the handle is a flat bar;
the locking member is a flat bar;
the locking member is shorter than the handle; and
flat faces of the handle are orthogonal to flat faces of the locking member.

20. The corner casting pin lock of claim 15, wherein the handle comprises a bend that enables an outside flat surface of the distal end of the handle to contact the locking tab, thereby preventing the corner casting pin lock from backing out of the pin lock aperture of the corner casting insert during transport.
